(19) United States
(12) Patent Application Publication
(10) Pub. No.: US 2015/0051925 A1
(43) Pub. Date: Feb. 19, 2015

(54) Open Date Ticketing Method and System

(71) Applicants: Jacob S. Yudin, Alpharetta, GA (US); Justin R. Wool, Miami, FL (US)

(72) Inventors: Jacob S. Yudin, Alpharetta, GA (US); Justin R. Wool, Miami, FL (US)

(21) Appl. No.: 13/966,682

(22) Filed: Aug. 14, 2013

(51) Int. Cl. G06Q 10/02

(52) U.S. Cl. CPC G06Q 10/02
USPC 705/5

(57) ABSTRACT

A method and system for selling seat tickets to one or more events in an event series, such as a season of home sporting games or concert series. The method includes setting aside groups of assignable seats to the events, offering open date ticket packages comprising open date tickets redeemable for tickets to the assignable seats, and accepting payment from purchasers in exchange for the ticket packages. The method further includes establishing a redemption deadline for an elected event before which a selected number of open date tickets in a ticket packages may be redeemed for a selected number of tickets to assigned seats chosen from the assignable seats at the elected event, with the selected number ranging between one ticket and all remaining open date tickets in the ticket package, and redeeming the selected number of open date tickets for the selected number of assigned seat tickets.

### TECHNICAL FIELD

This disclosure relates generally to ticketing for a series of events such as professional sporting games at a home stadium or a musical series at a particular concert venue, and more specifically to methods and systems for managing a flexible date or open date ticket package program for an event series such as a season of home games for a professional sports franchise.

### BACKGROUND

Many forms of “season” ticket packages to sporting events are offered by professional sports franchises and other sporting organizations. These range from plush box seats for a season to packages of only certain games such as weekend games. While there is a range of ticket package options between these extremes, virtually all options suffer from a recurring problem. All require a fan or other purchaser to make a commitment that very few can keep over a season of events—a commitment to attend events on fixed future dates that cannot easily be changed. This problem not only is frustrating and costly for purchasers and fans; it also closes off a relatively large portion of ticket sales for future games. This is because a certain percentage of season ticket package holders will not be able to attend a given game, and this cannot be known by the organization in advance. Consequently, these seats that could be re-sold and enjoyed instead go unused, the purchaser is out the cost of the ticket purchased before the season began, and the organization misses the opportunity to sell the unused seats to others.

Current sporting event ticketing systems simply are not capable of providing adequate flexibility to accommodate season ticket holders who are not able to attend a specific game or set of specific games within a ticket package that they may have purchased months previously. A need therefore exists for a method and system for providing or obtaining a multi-game ticket package that does not require a purchaser to commit far in advance to a certain number of seats for certain games on certain dates. A more general need also exists for a multi-game ticketing system that does not require a purchaser of a group of tickets to commit in advance to which game or games he or she wishes to attend or the number of seats that he or she wishes to use for a specific game. It is to the provision of a method and system of ticketing, redeeming, and upgrading the tickets in a multi-game ticket package that the present disclosure is primarily directed.

### SUMMARY

Briefly described, multi-event or multi-game ticketing methods and ticketing systems are disclosed that open up ticket sales to potential fans who seek increased flexibility in their support commitment of a sports team, a concert venue, a theatrical venue, or other event-based organization. In general, the methods and systems include selling a multi-event package of tickets in advance that provides the holder of the package the choice of when and how to use the tickets. In the case of an event series such as a season of home games for a sporting team, for example, a fan may purchase a package of ten open date tickets that are not date specific. In one aspect, the package of tickets includes an event-day classification corresponding to a sub-set of home games during the season having assignable seats for which the open date tickets in the ticket package can be redeemed. In another aspect, the package of open date tickets may correspond with a seating tier or classification of assignable seats having generally the same value. In accordance with the predetermined rules for the event series, the fan may redeem the open date tickets for assigned seats chosen from the pool of available assignable seats to any particular event that falls within the event classification, with the assigned seats being located in the seating tier associated with the package of open date tickets.

For instance, within a certain time window or prior to a redemption deadline before a particular game, the fan may go online and redeem one or more open date tickets from the package of open date tickets for assigned seats at the upcoming game. He or she may redeem only one open date ticket for the game, or the entire ten open date tickets for the game, or any number in between. The selection of the assigned seats from the pool of available assignable seats can be handled by the system, and upgrades to more desirable sections or seating tiers may also be available for purchase throughout the redemption window. After the passing of the redemption deadline or closing of the redemption window, the assignable seats not redeemed for that game may be released for normal sale to other fans.

Thus, an open date ticketing method and system are proposed that offer complete flexibility to purchasers of multi-game or multi-event ticket packages while at the same time offering flexibility and upgrades not currently available in standard season ticket packages. The ticketing method and system further offers the potential to sell more seats or more expensive seats to a particular event in the event series because it can be known after the time window for open date ticket redemption how many unredeemed seats are available for sale in each section. It is also believed that the open date ticket packages of the present disclosure will result in increased sales of multi-game ticket packages purchased in advance of a season.

The open date ticketing method and system of the present disclosure can provide greater flexibility to the seller of the multi-event ticket package by allowing for the expansion, contraction, relocation or removal of each seating tier for any particular event or game, in accordance with the market-based demand for that game. The flexibility can be manifested both as an initial static adjustment of the sizes and locations (i.e. the spatial configuration) of the various seating tiers prior to the opening of the redemption window, as well as an ongoing or dynamic adjustment of the seating tier assignments to the assignable seats at the host venue. The system also lends itself to the creation of a gift market that is much more flexible than current ticketing schemes. Companies or individuals, for example, can purchase a ticket package or packages and give packages or individual open date tickets within a package as gifts to clients or others without being concerned that the recipient may not be available for particular games. In addition, rained-out games and other unforeseen cancellations are much easier to handle. If a game is rained-out or canceled, then the open date tickets that were redeemed for that game are simply transferred back to the ticket package owner's account and can be used for the make-up game or for any other game in the future. All of this is done electronically and automatically through one or more domains or websites on the Worldwide Web. These and other features, aspects, and advantages of the ticketing system and methodology of this disclosure will become more apparent upon review of the detailed description presented below.

### BRIEF DESCRIPTION OF THE DRAWINGS

FIG. 1 is a schematic illustration of a tiered open date seating configuration for the home stadium of a baseball team, in accordance with a representative embodiment of the present disclosure.

FIG. 2 is a table showing a hierarchy for tier levels included the tiered open date seating configuration of FIG. 1.

FIGS. 3A-3C are schematic illustrations of variations on the initial tiered open date seating configuration of FIG. 1 for individual baseball games due to differences in the anticipated demand for each game, in accordance with another representative embodiment.

FIGS. 4A-4B are schematic illustrations of dynamic adjustments to the tiered open date seating configuration of FIG. 1 for an individual baseball game due to variations in the ongoing ticket sales for that game, in accordance with yet another representative embodiment.

FIG. 5 is a progression of schematic illustrations showing dynamic adjustments to the tiered open date seating configuration of FIG. 1 throughout the sales cycle for an individual baseball game, in accordance with yet another representative embodiment.

FIG. 6 is a flowchart illustrating one method for selling assigned seats to an event series, in accordance with yet another representative embodiment.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present disclosure described herein.

### DETAILED DESCRIPTION

A multi-event or multi-game, open date ticketing method and system is disclosed that involves selling a plurality of open date ticket packages for an event series, with each open date ticket package including a plurality of open date tickets, and with each open date ticket in the ticket packages being usable when and how the ticket package holder decides to use them in the future. The open date ticketing method and system may be considered “multi-event” because the open date ticket packages are generally sold for a plurality of designated events in an event series, and wherein any of the open date tickets included within the open date ticket packages can be redeemed in advance for any of the designated events included in the event series. The open date ticket package may also be considered “multi-event” because the tickets included therein may be applied to any one of the plurality of designated events in the event series, such as a number of home games during a baseball season.

There may be a requirement for at least a minimum number of open date tickets to be included in each open date ticket package. In one aspect, for example, the minimum number of new open date tickets made available for incremental purchases may remain constant for the duration of the event series. In other aspects, the minimum requirement can be greater for the initial purchase of an open date ticket package, and can then be reduced to a smaller increment as new open date tickets are added to an original open date ticket package, as discussed in more detail below.

The tickets of the open date ticket package are generally referred to herein as “open date tickets” because the holder has the option to redeem each open date ticket for an assigned seat ticket at any one of the plurality of designated events. The holder of a multi-event open date ticket package may decide to use several or even all of the tickets in the package for one single event in the group of available events, if it is desired to take friends and family along to that particular event. Alternatively, only a single ticket of the open date ticket package may be used for an event where just the package holder or another individual wants to attend alone.

With reference to applications in the professional sports, in one embodiment an open date ticket package can be sold in advance of a season of games with a predetermined number of open date tickets or attendances included in the package. There may be, for instance, 5, 10, 15, 25, or more event attendances or open date tickets included in the package for a commensurate price. Importantly, the purchaser does not purchase specific games to be attended by a specific number of people, but rather a specific number of attendances at one or more games in the future. For example, a ten ticket open date ticket package may be used by ten people to attend one game in the future, or by one person to attend ten games in the future, or any combination in between.

The open date ticketing method and system can have particular application in professional sports franchises, including but not limited to the sports of baseball, football, basketball, hockey and soccer. In these applications, the event series can comprise a season of home games at the stadiums, arenas or similar venues that are owned or operated by the professional sport franchises. Indeed, many embodiments of the open date ticketing method and system disclosed herein are related to the seating and ticketing at the home stadium for teams in professional sports leagues, and in particular for teams in Major League Baseball™. It is to be appreciated, however, that the present disclosure has application beyond baseball and the major professional sports organizations, and the open date ticketing method and system may also be applied to event series such as a season of college sports, a season of musical concerts at a concert venue, or even a season of sporting events having similar seating arrangements but at different geographical locations, such as those venues prepared for the alpine and winter sports, auto-racing, extreme sports, golf, and the like.

With additional reference to the professional sports embodiments, the franchise or original seller can open the parameters of a multi-game, open date ticket package to allow the open date tickets to be redeemed for assigned seat tickets to any of the home games of the season. In other aspects, the seller can limit the parameters of the ticket package, through an event-day classification or similar designation, so that the open date tickets may only be redeemable for games that fall within that predetermined event-day classification. For instance, the basis for the event-day classification may include the day of the week of the game (e.g. weekday games, weekend games, holiday games), the time of day of the game (e.g. afternoon games, evening games), a block of games based on opponents (e.g. games against non-division opponents, games again rival opponents), or for games that take place during selected time periods (e.g. spring games, games during the month of June, and the like). The package holder can redeem the selected or chosen number of tickets from the ticket package for the game or games taking place on the dates of his or her choice, so long as the game or games fall within the package's parameters or event-day classification.

The sellers of the open date ticket packages can customize and price the event-day classifications with the intent of maximizing attendance at the events series. For instance, open date ticket packages with limited event-day classifications can be sold at a discount to encourage attendance at games with traditionally low turn-outs. In another aspect, the purchaser of the open date ticket package may be given the opportunity to customize the event-day classification of the open date ticket package at the time of purchase, as well as select the number of open date tickets to be included in the package, with the seller adjusting the price for the customized open date ticket package accordingly.

The open date ticketing method for selling assigned seat tickets generally includes setting aside groups of assignable open date seats to the events. The assignable open date seats, or assignable seats, can be distinguishable from the standard seats in the stadium that are available for purchase using traditional methods, such as the advanced purchase of reserved seats for season ticket holders, the on-line or direct sale through the stadium box office prior to game day, or the direct sale through the stadium box office only on the day of the game. In contrast, the assignable seats can be set aside for being exchanged or redeemed with open date tickets, and are not available for general sale until after the closing of the time window or the passing of the redemption deadline. At the time of redemption of the open date tickets, the assignable seats become assigned seats with the holder(s) of the exchanged open date tickets now holding assigned seat tickets.

The proportions of standard seats and assignable seats in the various seating sections in the stadium can vary between seating sections. In addition, the assignable seats that have been made available for the holders of the open date tickets can be grouped together in one or more blocks of seats in any particular seating section, or may be scattered among the standard seats. The number and location of the assignable seats within a particular seating section may also vary throughout the course of the event series, as more assignable seats may be set aside if the number of purchased open date ticket packages increases, or the pool of available assignable seats may be reduced as the total number of unredeemed open date tickets is reduced.

The open date ticketing method and system also includes offering a plurality of open date ticket packages, with each package including a plurality of open date tickets that are redeemable for tickets to the assignable seats. As described in more detail below, the open date ticket packages can vary both with regard to the type or classification of designated games for which the open date tickets can be redeemed, as well as the level of seating at those designated games. The method also includes accepting payment from purchasers in exchange for the open date ticket packages.

The open date ticketing method and system generally includes establishing a redemption deadline or time window prior to each game of the season, during which open date ticket package holders can redeem one or more open date tickets in their package for one or more of tickets to assigned seats that are chosen from the available assignable seats at the upcoming game. As described above, the selected number of tickets used for any particular game can vary between one ticket and all of the remaining open date tickets in the ticket package. Furthermore, the method can also include redeeming the selected number of open date tickets for the selected number of assigned seat tickets.

The redemption can take place online through a hosted domain on the Worldwide Web, with ticket package holders going to a website and indicating the number of tickets of their packages that are being redeemed for the upcoming game. In one aspect, the ticket holder can employ a customized application, or “app”, that has been downloaded to a smartphone, tablet PC or similar device, and that connects via the Internet or Worldwide Web to a hosted domain or website powered by computer servers that operate and manage the multi-event ticketing system. In other aspects the ticket holder can use a general purpose personal computer or similar device to connect to the host domain or website. In addition, the multi-event ticketing system may be managed by software that controls the website of the plan at the hosted domain, as well as the online accounts of package holders, the management, redemption, and upgrading of open date tickets, the release and resale of unredeemed or otherwise available seats, the approval of open date tickets for admission at the gate (or the printing of actual tickets upon presentation of a redeemed open date ticket), and all of the other functions of the ticketing system.

At the time of purchase (which can take place via the hosted domain on the Worldwide Web, the stadium box office, or similar sales outlet), the purchaser may be required to establish an online account through which he or she may manage, redeem, and/or upgrade the open date tickets of a purchased package.

As stated above, a redemption deadline or window can be established prior to each game of the season. Before the passing of the deadline or closing of the window, the open date ticket holders who wish to attend that game can redeem their open date tickets for assigned seats chosen from the available assignable seats at the elected game. After the closing of the time window or the passing of the redemption deadline, the open date tickets may continue to be redeemed if there are still assignable seats available in the stadium or venue. This might happen, for instance, at the gate, where an open date ticket may be presented and its holder either allowed admission or not depending upon whether any assignable open date seats are still available. Generally, however, after the passing of the redemption deadline the unredeemed assignable seats may be converted or released as standard seats and made available for purchase using traditional methods, thereby increasing revenue and profits for the organization sponsoring the event.

While the method and system of the present disclosure can create needed flexibility for the open date ticket package holders, it also can create favorable opportunities for the stadium or sports franchise. For instance, after the passing of the deadline for redemption of the open date tickets, the stadium will know how many open date tickets will have been redeemed for the assignable seats in each seating section at the game. Of equal importance, the stadium will also know how many assignable seats have not yet been redeemed in each section and that will likely not be occupied by open date ticket holders at the game. As stated above, the unredeemed assignable seats can be converted and sold as standard tickets at the gate, announced as available on the radio, or otherwise disposed of to other fans. Additionally, the unredeemed assignable seats in the more desirable sections of the venue may also be offered for sale as upgrades to other season or open date ticket holders, given as concessions, or used in another profitable manner by the organization.

The timing of the redemption deadline can be variable, depending on the strategy of the sellers of the open date ticket packages for maximizing attendance at the game or event. For example, in one aspect the redemption deadline can be several weeks in advance of the start of the game, such as during a pre-sale period, so as to provide ample opportunity to sell the unredeemed and converted assignable seats as standard seats using traditional sales methods. In another aspect, the redemption deadline or closing of the redemption window can generally be scheduled a day or two before the start of the game to provide greater encouragement and opportunity for the open date ticket holders to redeem their tickets. Alternatively, the redemption deadline may also be scheduled to coincide with the start of the game or even after the start of the game if, for example, it has been determined that allowing the holders of the open date tickets to continue to redeem their open date tickets rather than purchase standard tickets can increase attendance and revenue.

In another aspect of the open date ticketing method, the redemption of the open date tickets at the game or event may not be limited by the closing of a redemption window or the passing of a redemption deadline, but instead may be limited by the assignable seats being redeemed on a first-come, first-serve basis by the open date ticket holders. In other words, the holders of open date tickets may redeem their open date tickets for assignable seats up until the start of the game or even after the start of the game, so long as there are assignable seats that remain available for redemption. In this embodiment, moreover, the assignable seats can be set aside as a block of seats that are distinguishable from the standard seats in the stadium that are available for purchase using traditional sales methods, as described above. Alternatively, instead of setting aside groups of assignable open date seats from the standard seats, each of the remaining unsold seats in the stadium or venue may be made available, on a first-come, first-serve basis, either for sale as a standard seat using traditional sales methods or for redemption with an open date ticket.

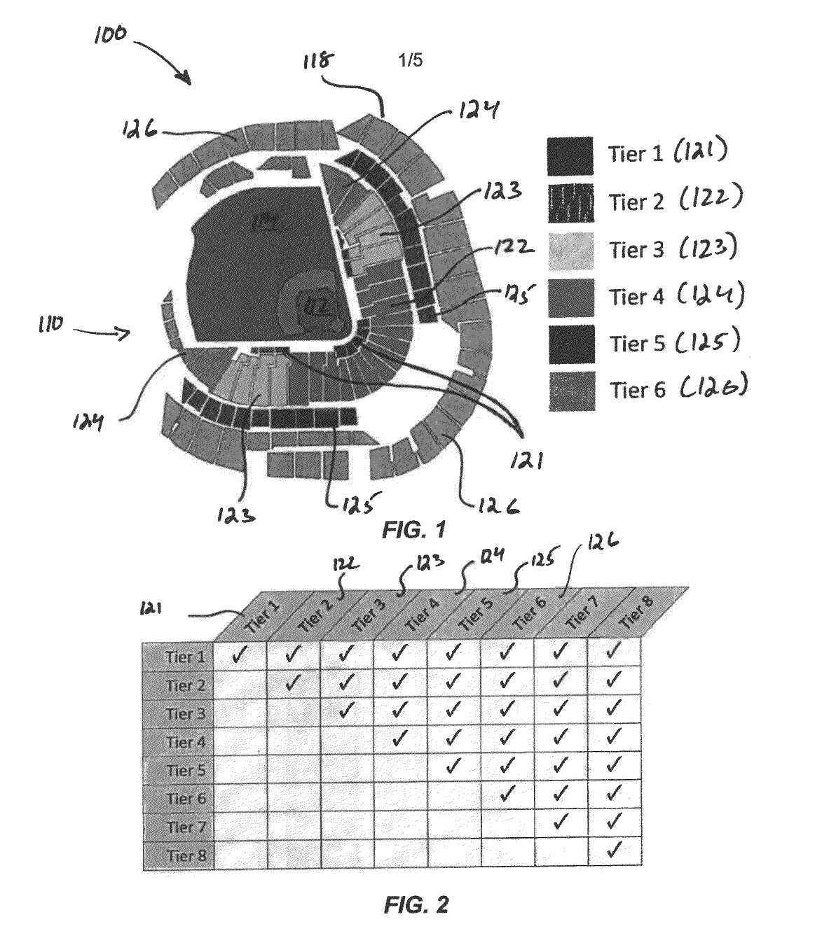

In accordance with another embodiment of the open date ticketing method and system, the assignable open date seats in a venue hosting the event series can be subdivided into a plurality of seating tiers, with each of the assignable seats in a seating tier having substantially the same value. A schematic illustration of one exemplary embodiment of a tiered open date seating configuration 100 for the baseball stadium 110 of a baseball team is provided in FIG. 1, in which the assignable open date seating in the stadium has been subdivided into six tiers, with the Tier 1 seating level 121 being associated with the most valuable group of seats directly behind home plate and near to the dugouts in close proximity with the players. The Tier 2 seating level 122 can be associated with the next group of seats having a very high value, such as those surrounding the infield 112. This hierarchy can continue from the next group of seats having a high value, such as the Tier 3 seating level 123 adjacent the outfield 114, through to the lower value Tier 6 level seating 126 located on the upper deck 118.

The tiered open date seating configuration 100 shown in FIG. 1 may or may not coincide with a tiered configuration for the standard seats in the stadium 110 that are available for purchase using traditional methods (e.g. the reserved seats for season ticket holders or the seats purchased through direct sale on-line or through the box office prior to game day). Generally, however, the open date tiered configuration 100 and the standard seat tiered configuration do not coincide because the two ticketing systems can be configured to operate under different principles, and in a manner that provides the stadium or host venue with additional flexibility in allocating the total number of seats and utilizing the stadium for maximum revenue and profit. For instance, the tiered configuration for the standard seats in the stadium (not shown) can generally be fixed in location and variable in price, with the prices for the tickets in a particular tier level being adjusted in the days and hours before game day depending on the market demand for the game. In contrast, the tiered configuration 100 for the open date tickets and assignable seats in the stadium 110 shown in FIG. 1 can generally be fixed in price or value (since the open date ticket packages have are pre-sold weeks or months in advance) and variable in their arrangement and location.

At the time of purchase, an open date ticket package may be purchased for a particular open date tier level of seats. For example, the package may be for field level seats (e.g. Tier 1 seating level 121 shown in FIG. 1), terrace level seats (Tier 5 seating level 125), upper level seats (Tier 6 seating level 126), and the like, and with every seat within a particular tier seating level having substantially the same value. As apparent to one of skill in the art, some tier seating levels will be more valuable than others because of their proximity to the game and the players. Consequently, open date ticket packages that are associated with assignable seats located in the more valuable tier seating levels can be priced correspondingly higher than the open date packages associated with assignable seats in less desirable tier seating levels.

Since the tier seating levels are organized and grouped based on equivalent value of the seats they contain, a hierarchy can exist within the tier level structure. FIG. 2 is a table showing the hierarchy of the tiered open date seating configuration of FIG. 1, with the Tier 1 seating level 111 being the most valuable and the Tier 6 seating level 116 being the least valuable. As shown, an open date ticket in a more valuable tier level can be redeemed for an assigned seat in that same tier level or in any lower tier level. Thus, open date tickets in the Tier 1 seating level 111 can be redeemed for assigned seats in any lower tier level, while open date tickets in the Tier 6 seating level 116 can only be redeemed for assigned seats in Tier 6. This hierarchy can allow the holder of an open date ticket in a higher-valued seating tier to essentially sacrifice a part of the value of his or her ticket in order to sit in a location having a more preferred viewing angle (even if it means sitting in a less expensive seat), or to sit with an acquaintance or family member that has a lower-valued open date ticket. In other words, any fan that purchases a higher valued open date ticket has also purchased the capability to intentionally downgrade his seating preferences as they choose to do so. This capability come as a benefit to the franchise or seller of the open date ticket package, which stands to increase its profit margin any time an open date ticket holder redeems a higher valued open date ticket for an assigned seat in a lesser valued seating level.

In addition to the option to intentionally downgrade the value of an open date ticket to sit in a lower seating level, the holder of an open date ticket package may also be given the opportunity to upgrade to an assigned seat in a more desirable section or tier level of the stadium at a prorated price at the time that an open date ticket is redeemed. In one aspect, the offer of an upgrade and the prorated price can be based upon the probability that a seat in the upgraded section will be sold prior to the game, the number of available assignable seats in the upgraded section, how soon the game is to begin, historical last minute sales information, and the like. If an upgrade is offered, accepted, and paid for, the ticket package holder will be given an assigned seat in the more desirable section or tier level, that seat will be removed from the list of available assignable seats in the upgraded section, and the assignable seats in the tier level for which the ticket package was originally purchased remain available for redemption by other open date ticket holders or for purchase as a standard seat through normal ticketing channels after the passing of the redemption deadline. Thus, the ticket package holder gets the occasional upgrade, the organization realizes incremental income from the more desirable seat, and the organization is able to redeem or sell the assignable seats that remain in the original section or tier level.

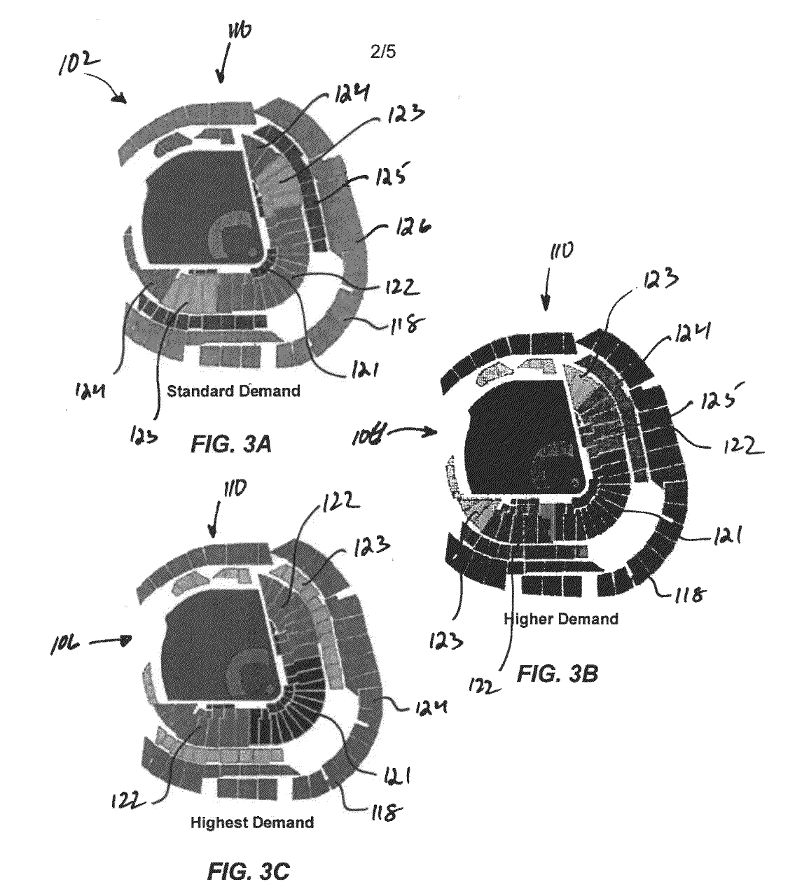

The initial tiered open date seating configuration 100 illustrated FIG. 1 may vary between games in accordance with differences in the anticipated demand for each game, as shown in FIGS. 3A-3C. For example, the initial tiered open date seating configuration 102 for a Standard Demand type of game against most opponents during a baseball season (FIG. 3A) can substantially correspond with the tiered open date seating configuration 100 illustrated FIG. 1. For the Standard Demand game, all six tier levels are included in the tiered open date seating configuration 102, indicating that all holders of open date tickets have the ability to redeem their open date tickets for an assigned seat for the game while assignable seats remain available in their tier level. One may note that the Tier 6 seating level 126 includes the entire upper deck of the stadium 110, meaning that fans using a Tier 6 open date ticket can only redeem their open date tickets for an assigned seat in the upper deck for this game. One may also note that the Tier 1 seating level 121 covers those seats immediately behind home plate or located in the front rows near the dugouts, and can only be assigned to fans redeeming Tier 1 open date tickets (or those who pay a pro-rated amount for each ticket to upgrade to the premium seats). As stated above, the open dates tickets that are associated with the more valuable tier levels may always be redeemed for assigned seats in a lower valued tier level.

For the High Demand game shown in FIG. 3B, the initial tiered open date seating configuration 104 can be modified so that the Tier 5 seating level 125 seating level that was originally located on the terrace level 116 has been shifted away from the playing field and expanded to fill the upper deck 118 of the stadium, with the Tier 6 seating level no longer being present or available for redemption. Thus, fans who purchased Tier 6 open date tickets will not be able to redeem their open date tickets for assigned seats during this High Demand game. This change in the initial tiered open date seating configuration 104 for High Demand games can reflect the increased demand for tickets to games against divisional opponents or on typical weekend games, and is generally consistent with the price paid for the Tier 6 open date tickets.

In the infield area, the Tier 1 seating level 121 can expand to include much of the seating area previously assigned to the Tier 2 seating level 122, with the Tier 2 seating level 122 shifting into the area previously occupied by the Tier 3 seating level 123, and so on. As a result, more of the assignable seats in the stadium can be made available for redemption at the higher tier levels, giving more of the holders of the higher valued open date tickets a greater opportunity to attend the High Demand game.

The expansion of the higher value tiers at the expense of the lower value tiers can be further extended to the initial tiered open date seating configuration 106 for the Highest Demand games shown in FIG. 3C, such as may occur on holidays, primetime weekend games or high-profile games against special opponents and rivals. In this case, the Tier 4 seating level 124 that originally covered the seating sections located in the corners of the lower deck for the Standard Demand games (FIG. 3A) has been moved away from the playing field and expanded to fill the upper deck 118 of the stadium, with both the Tier 5 and Tier 6 seating levels no longer being present or available for redemption. Tiers 1-3 have also been expended accordingly to cover the entire lower deck and terrace seating levels.

The above method of shifting the size and location (i.e. the spatial configuration) of the open date seating tiers contrasts generally with existing sales practices for standard tickets, in which the location and pricing tiers for the standard seats do not move, but instead the initial prices for the standard seats in each seating tier are increased for the High Demand and Highest Demand games as the franchise seeks to capture additional revenue for the games that statistically sell out the quickest. Thus, one advantage for open date ticket holders is that even those with lower valued open date tickets may have the ability to supplement their current portfolio of open date tickets by redeeming their open date tickets, for a fee, for more valuable assigned seats. The flexibility of mixing tickets of varying value and seating sections can be advantageous to both the fans and the sports franchise by providing another method that incentivizes fans to occasionally indulge in excess spending and attend a preferred game they might otherwise miss, while also allowing the franchise to capture an incremental increase in profits.

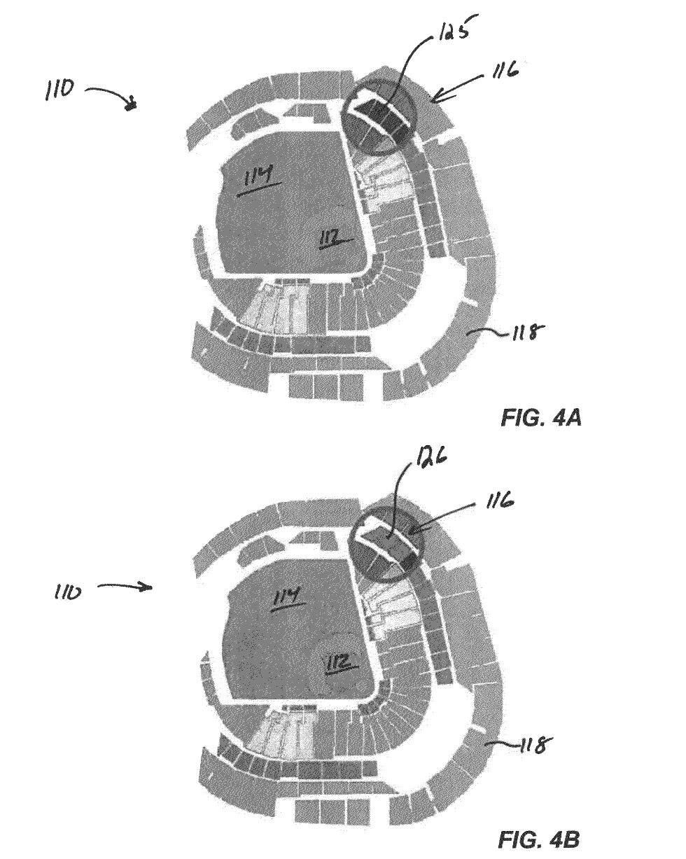

In another aspect of the open date ticketing method and system, and in addition to the differences in the initial seating configurations described above, the size and location of the open date seating tiers may dynamically vary for any particular game up until the day the redemption window closes or alternatively, as disclosed above, up until the start of the game or even after the start of the game. For example, in the case of the Standard Demand game illustrated in FIG. 4A, all of the seating sections found in the terrace level 116 in the stadium 110 may be assigned to the Tier 5 seating level 125 when the redemption window first opens, typically several weeks before game day. If it is noted during the sales cycle, however, that a few seating sections 117 located to one end of the terrace level 116 are significantly undersold after a few weeks, the tiered seating assignment for those sections can be changed to the Tier 6 seating level 125 (FIG. 4B). This means that fans holding Tier 6 open date tickets can now redeem their tickets for assigned seats in these sections in addition to the fans with Tier 5 open date tickets. This can operate to create additional demand for the undersold section 117 as the holders of Tier 6 open date tickets are more likely to take advantage of this change because it allows them to sit in better seats than they are normally accustomed.

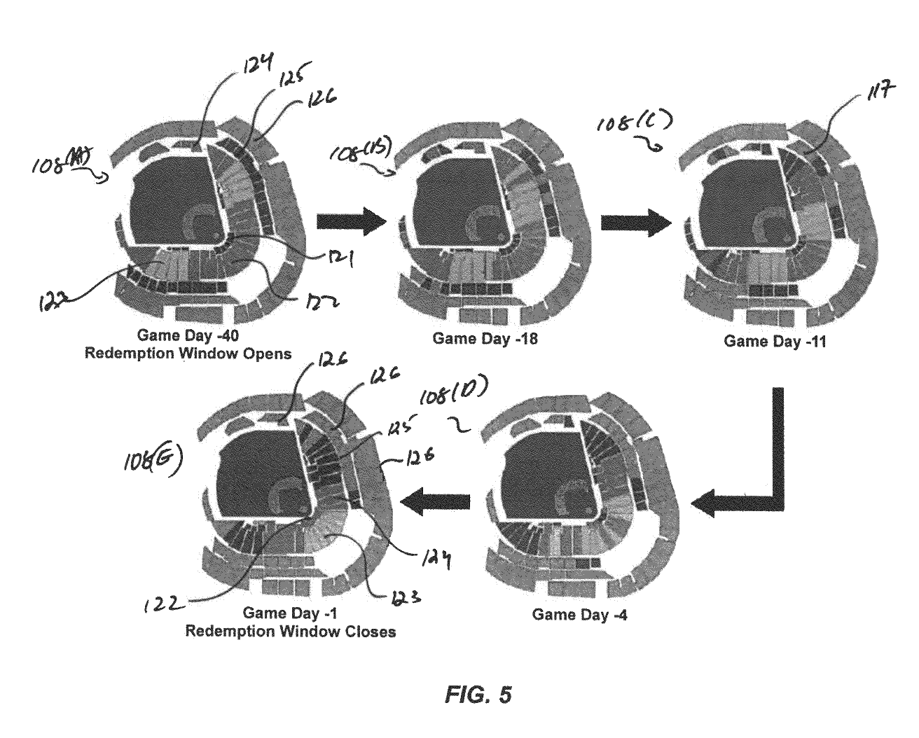

These dynamic changes can occur throughout the redemption window for individual sections (and portions of sections) in the stadium, depending on the selling rates of the seats in those sections. As shown in FIG. 5, for example, in the initial tiered open date seating configuration 108(A), the seating sections in the lower deck in the outfield were assigned to the Tier 4 seating level 124 on the day the redemption window opened. Those same seating sections had been reassigned to the Tier 6 seating level 126 in the final tiered open date seating configuration 108(E) on the day before game day, when the redemption window closed. Similarly, every assignable seat in the Tier 1 seating level 121 had also become eligible for redemption with a Tier 2 open date ticket in the final tiered open date seating configuration 108(E). Thus, in some circumstances the dynamic modification of the tiered open date seating configuration 108(A)-108(E) can substantially increase the buying power of fans with lower-valued open date tickets.

The application of dynamic changes to the tiered open date seating configuration can provide several additional benefits to the open date tickets holders as well as to the sports franchise operating the stadium and ticketing system. For instance, each change to the map or configuration of the tiered open date seating can provide an additional opportunity to reach out to the fans and entice them to attend a game that would otherwise be undersold, simply by presenting the opportunity to redeem their lower valued open date ticket for an assigned seat in a tier level that is substantially better than the tier level they originally purchased. Consequently, the fans can feel richer and more satisfied with their original purchase of the open date ticket package while the attendance at the ballpark can be increased with a more rapid depletion in the outstanding number of open date tickets, which in turn leads to increased sales and higher revenues in the form of increased stadium purchases.

As stated above, in some aspects the number and location of the assignable seats within a seating section or a seating tier may vary up until the closing of the time window or the passing of the redemption deadline or alternatively, up until the start of the game or even after the start of the game. The variations in the size and location of the open date seating tiers and the number and location of the assignable seats within those seating tiers can reflect changes in the market demand, selling trends of the standard tickets for that particular game, and redemption of open date tickets for that particular game. Generally, however, the number of assignable open date seats set aside for any particular game or event will be greater than the number of open date tickets expected to be redeemed, in accordance with the anticipated demand for that particular game.

In accordance with another embodiment of the open date ticketing method and system disclosed above, the redemption of the open date tickets at any particular event may not be limited by the closing of a redemption window or passing of a redemption deadline, but instead may be limited by the open date tickets being redeemed on a first-come, first-serve basis by the open date ticket holders. This embodiment of the open date ticketing method and system can have particular application with dynamic tiered open date seating, such as with the exemplary changes to the tiered open date seating configuration 108(A)-108(E) discussed above with reference to FIG. 5.

For example, the sellers of the open date tickets can continuously change the spatial configuration of the tiered open date seating map up to the start of the game to entice more open date ticket holders to redeem their open date tickets. These changes can include variations in the size and location of the open date seating tiers. In cases where assignable open date seats are aside from the standard seats in the stadium, the open date ticket holders may redeem their open date tickets for assignable seats in the initial seating tier (or in a downgraded or upgraded seating tier, as discussed above) up until the start of the game or even after the start of the game, so long as there are assignable seats that remain available in that seating tier for redemption.

Alternatively, in cases where each of the remaining unsold seats in the stadium or venue is made available either for sale as a standard seat or for redemption with an open date ticket on a first-come, first-serve basis, the open date ticket holders may redeem their open date tickets for assigned seats in the initial open date seating tier (or in a downgraded or upgraded seating tier, as discussed above) up until the start of the game or even after the start of the game, so long as one or more seats remain available in that seating tier for redemption or purchase. In this aspect of the present disclosure, moreover, each of the remaining unsold seats in the stadium may be assigned to two different types of seating tiers: a standard seating tier, wherein the cash value of the available seat varies before the game; and a variable open date seating tier, wherein the tier level of an open date ticket that can be redeemed for the available seat varies before the game.

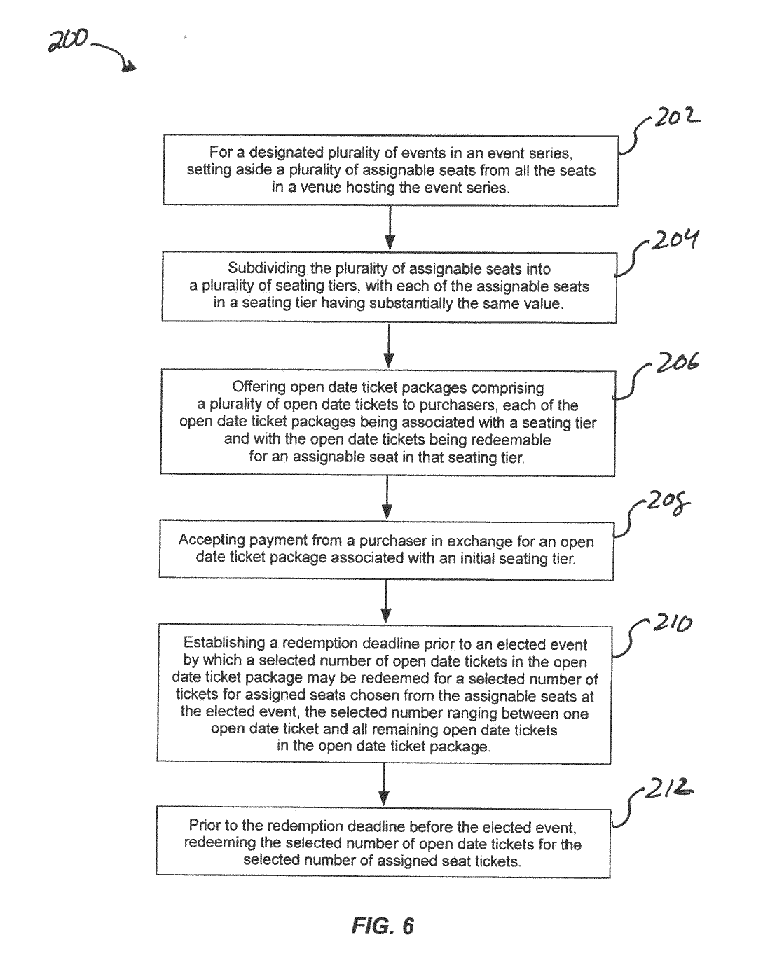

FIG. 6 is a flowchart illustrating one embodiment of the open date ticketing method 200 for selling assigned seats to an event series. The method 200 includes the steps of setting aside 224 a plurality of assignable seats from all the seats in a venue hosting the event series, for a designated plurality of events in the event series, and subdividing 204 the plurality of assignable seats into a plurality of seating tiers, with each of the assignable seats in a seating tier having substantially the same value. The method 200 also includes offering 206 a plurality of open date ticket packages to purchasers, with each of the open date ticket packages comprising a plurality of open date tickets and being associated with a seating tier, and with the open date tickets being redeemable for an assignable seat in that seating tier, as well as accepting 208 payment from a purchaser in exchange for at least one open date ticket package associated with an initial seating tier. The method 200 further includes establishing 210 a redemption deadline prior to an elected event by which a selected number of open date tickets in the at least one open date ticket package may be redeemed, the selected number ranging between one open date ticket and all remaining open date tickets in the at least one open date ticket package, and prior to the redemption deadline, redeeming 212 the selected number of open date tickets for a selected number of assigned seat tickets chosen from the assignable seats at the elected event.

The open date ticketing method and system described herein can create enhanced opportunities for sports franchises to offer ticketing packages to fans that will allow the fans to buy a group of tickets without having to commit to particular dates or number of attendees at the time of purchase. Other aspects of open date ticketing method and system address issues surrounding normal variations in prices of tickets per game (e.g. weekend game tickets may be more expensive then weekday game tickets), the different needs of organizations that exist within the league such as varying market sizes, and the need to quantify the maximum number of open date ticket packages can be sold without selling more tickets than there are seats available.

In one embodiment of the present disclosure in which the open date tickets do not carry over into the next season, the sports franchise or seller of the open date ticket packages generally cannot issue more tickets, including standard tickets and open date tickets, than it has seats available for any particular game. This typically is not an issue as the number of assignable seats and reserved season tickets in any particular section are less than the total number of seats in that section, with the remainder being available for sale through normal sales channels up to the start of the game.

In circumstances where a venue is very popular with a high number of reserved season tickets, the open date ticketing method and system may account for this restriction by first determining the total number of seats available throughout the duration of a particular open date ticket package (e.g. an entire season, the first half of the season, weekend games only, etc.). For example, assume that the number of total seats available throughout the season (i.e. those seats not reserved by the holders of season tickets) in a certain section of the stadium is X. Open date ticket packages for the season can be sold until the sum of standard tickets available in that section plus the number of assignable seats that are redeemable by the open date tickets in that section is equal to X. This means that if an organization obtains combined sales of standard ticket and open date tickets of X for a section during the entire season, then sufficient tickets, both standard and open date, have been issued to sell out the entire section for every game the season.

Such a “season sell out” condition for a particular section of the stadium does not prevent an organization from continuing to sell traditional tickets in such a “sold out” section. It only prevents the sale of additional open date ticket packages with seats that can be redeemed in that section. Since the redemption period for seats from open date ticket packages preferably ends prior to the beginning of ticket sales on the day of the game, all assignable seats in a “sold out” section that were not redeemed can be purchased by fans at the gate. This allows the organization to maximize profit for available seats in the section for each game, and, theoretically, exceed the profits that would be generated by 100% attendance. The organization may also apply dynamic pricing for the unredeemed assignable seats in a section to increase profits even more. For example, an organization may alter the prices at the gate when the ticket office opens in order to increase the likelihood that more valuable seats are sold.

In another embodiment of the present disclosure, however, the open date tickets included in the ticket packages may not be limited to a particular season or expire at the end of the original event series, and may be configured to carry over to the next event series if the open date tickets remain unredeemed at the conclusion of the original event series. In one aspect, the open date tickets may carry over to the next event series with their same value. Alternatively, the tickets may carry over with a depreciated value that encourages the holders to redeem their open date tickets during the current event series whenever possible, but does not result in a complete loss of the purchased value of the open date tickets if it is otherwise not possible to redeem the tickets during the original event series.

The duration of the predetermined time window or timing of the redemption deadline before each eligible game can remain consistent throughout the season. In addition, restrictions can be implemented to safeguard against any potential problems created while interfacing with the current ticket systems in place, and to ensure that there is no interference with other standard ticket sales. It is to be appreciated, moreover, that the open date tickets can be given, exchanged, and traded freely, so long as the eventual holder redeems the ticket before the end of the time window or redemption deadline. In one aspect, the open date ticket can be formatted with a bar code or similar identifier for scanning at the gate, with the ticketing computer approving the open date ticket for admission and providing the fan with a paper or electronic ticket to the assigned seat chosen from the pool of assignable seats at the time the open date ticket was redeemed. Alternatively, paper tickets corresponding to redeemed open date ticket can be printed and made available at will call, at the gate, or at another location.

Rained-out games and canceled events currently are difficult and expensive to handle in terms of managing the tickets of fans that were to attend a game that was rained-out. Further, the rain checks provided to fans are usually only good for the rescheduled make-up game and many times a fan is not available to attend the make-up game. In one aspect, the open date ticketing method and system can used to resolve these issues. If a game to which an open date ticket has been redeemed is rained-out, the open date ticket option can simply be returned to the account of the ticket package holder. The package holder can then re-redeem it for attendance at the scheduled make-up game or use it in the usual way to attend any other game within package parameters in the future. All of this can be handled electronically and automatically so that managing attendance at a rained-out game is simple, easy, and automatic. Further, if open date tickets are not redeemed for the scheduled make-up game, then more standard tickets to the seats can be sold to the make-up game at the gate, which may be advantageous particularly for popular match-ups.

In another aspect of the open date ticketing method and system related to upgrading and account management, each open date ticket can represent a real dollar amount that is equal to the average of cost of a ticket in the plan. For instance, if the total cost of tickets in an open date ticket package is $100.00, and the purchaser purchased additional options (e.g. upgrades) that made the total cost of the package $120.00, then the assigned value of each open date ticket in the package is $12.00. If the purchaser or a fan wants to upgrade one of the open date tickets for a particular game to a seat that costs $25.00 without using an upgrade option in the package, then the assigned $12.00 value of the open date ticket for the game can be deducted from the upgraded seat price and the purchaser or fan can pay the difference to upgrade one or more tickets in the open date ticket package.

In some embodiments of the present disclosure, options to choose open date ticket packages may be set up to supplement current ticketing packages and standard ticketing practices, as generally described above. Alternatively, the open date ticketing system of the present disclosure may be established as the sole or primary mechanism for offering ticketing in multi-game ticket packages.

The features, options, controls, and restrictions that are offered to purchasers will most likely be directly related to the anticipated attendance foreseen by the venue, stadium or sports franchise. For instance, the smaller the attendance or expected attendance at a particular game, or the smaller the attendance at a particular stadium or for a particular franchise, the fewer restrictions need be implemented and the options for upgrades, etc, can be commensurately greater.

It is to be appreciated that the open date ticketing method and system can also give rise to a newly vitalized gift market for ticket packages. Under current pre-selected game date packages, it is very difficult to give tickets to clients or others very far in advance of a game because it must be confirmed that the recipient is indeed available to attend the game to which tickets are being given. With the open date ticketing system, however, entire open date ticket packages for a season, a group of games, a time period during a season, or individual tickets from such packages can easily be gifted without concern whether the recipient is available for a particular game or not. The recipient can choose any game he or she wishes to use the gifted tickets for. Accordingly, it is expected that ticket sales will increase due to the creation of a viable and flexible gift market for open date ticket packages.

The gifts of open date tickets can be presented in several formats. In one embodiment, for instance, the gifted open date tickets can simply be individual, bar-coded and scannable physical tickets selected from the plurality of physical open date tickets included in an open date ticket package purchased by the original owner. These physical tickets may have been electronically assigned to the owner at the time of purchase or when he or she established an online account through the hosted domain or web-based redemption portal, as described above. As a deterrent to theft and fraud, each individual open date ticket may only be assigned to one on-line account at a time once the ticket has been entered into the open date ticketing system and made available for redemption. Thus, in one aspect of the open date ticketing system, the owner may be given the option on the web portal to release the individual gifted open date tickets so that the recipient can use the open date tickets to establish his own online account.

In another aspect, an intended gift of an open date ticket package may be purchased on-line by a buyer who provides an e-mail address, a phone number, a mailing address, or similar personal contact information for the intended recipient at the time of purchase. The open date ticketing system can then be directed to contact the recipient to inform him or her of their electronic open date ticket gift package that includes electronic credit for a predetermined number of open date tickets included in the open date ticket package, along with instructions on how to establish a new on-line account or to enter the information for their gifted open date tickets into an existing account. In this case, the open date tickets may not be printed in physical format, but instead may remain as electronic credits available in the ticket holder's online account.

In yet another aspect, electronic credit for an open date ticket package can be uploaded to a open date ticket gift card that is subsequently presented for sale on gift card racks available at supermarkets, departments stores, and other retail outlets. A purchaser can buy the gift card at the retailer's register in the same way that one may buy a similar gift card for a restaurant or a retail store, and then provide the open date gift card to the recipient at the time of his or her choosing. As with the method and system described above, the recipient can then access or establish his or her own online account and enter the information printed on the open date ticket gift card to transfer the electronic credit for the open date tickets from gift card to the recipient's online account. To deter theft and fraud, the electronic credit uploaded to a open date gift card may be rendered unavailable until after the gift card has been properly purchased at the retailer's register.

In each of the embodiments that utilize open date tickets in electronic format, the electronic credit for the open date tickets can include both the open date ticket event-day classifications and the open date ticket seating tier classifications disclosed above. A number of different combinations of event-day and seating tier classifications for the gifted electronic open date ticket packages can be determined in advance by the sports franchise or seller of the open date ticket packages, and presented in an on-line gift store to the potential buyer as options. Alternatively, the buyer may also be given the option to prepare a customized electronic open date ticket gift package or a customized open date ticket gift card having a credit for a buyer-defined quantity, event-day classification, and seating tier classification for the open date tickets.

It is to be appreciated that the gift market for ticket packages may not be limited to the particular season or time of year when the event series takes place, and may be particularly active during the winter holidays. Consequently, the expansion of the open date ticketing method and system into the gift market can provide fans with greater options to give or receive gifted open date ticket packages, as well as provide the franchise owner or sellers of the open date ticket packages with improved opportunities to sell more tickets and increase attendance at their games or event series.

In yet another embodiment of the present disclosure, the open date ticketing method and system may include the option for corporate ticket management of a corporate package of multi-event open date tickets to the event series, such as a season of home games for a professional sports franchise. The use of open date ticket packages for corporations, as opposed to the season ticket packages with fixed-seating that are traditionally used, can provide additional flexibility and increased benefits for both the corporate customers of the event series and for the sports franchise. As may be appreciated by the skilled artisan, corporate purchasers can use the flexibility provided by the open date tickets to better accommodate the schedules of their own employees and the clients who they wish to entertain at the elected events. In addition, the sports franchise is given the opportunity to sell the unredeemed assignable seats on the open market at prices that can often be higher than those of the open date tickets.

In the corporate ticket management, user-designated account managers can be given administrative access to the business's online account with the open date ticketing system, and can thereby control the distribution of the open date tickets in the corporate account in accordance with the entertainment requests of employees, managers and officers, and guided by the availability of the clients who they wish to entertain. For instance, the corporate account managers can assign a defined group of open date tickets to an employee, manager or officer for the express purpose of taking a particular client to a game. Within the parameters of the corporate open date ticket package, the corporate account manager no longer has to prioritize requests from different clients for the same fixed seats, but can simply allow each member of the corporation to coordinate their schedules with their own clients, even with both groups attending the same game or both delaying attendance until a more convenient opportunity to attend with their clients becomes available.

In addition to controlling the distribution of open date tickets, the account manager can set up separate in-house accounts for each employee, manager or officer who will be utilizing the open date tickets, purchase new open date ticket packages with selected combinations of event-day and seating tier classifications (with the higher value combinations generally being utilized by officers and managers to entertain the corporations more important clients), and transferring un-used open date tickets between in-house accounts.

### EXAMPLES

Following are some examples of open date ticketing options that may be implemented by an organization, such as a sports franchise, in accordance with the open date ticketing method and system disclosed herein and depending upon the circumstances and needs of the organization.

### Example Option 1

In one exemplary embodiment of the open date ticketing method and system, the purchasers of open date ticket packages may select not only how many open date tickets they wish to purchase in a package, as well as the section, sections or open date seating tiers of the stadium to which those tickets apply, but also will specify the event-day classification for which they will redeem their tickets. For instance, a package purchaser may specify a specific time period or time window, such as April, May, and/or June, which usually see lower attendance, or July, August, and/or September, which traditionally are associated with higher attendance. The price of the open date ticket package is then determined with, for example, the lower attendance month packages costing less and the higher attendance months costing more. Further, depending on the size of the market a team plays in, various sub-options within the package may be offered such as Weekday games only, Weeknight games only, Weekend games only, or all games during the selected months. The cost of the customized open date ticket package can then be determined based upon an assigned value of tickets to games within the selected windows.

According to another aspect, if a purchaser buys a predetermined number of open date tickets in a package (e.g. 100 tickets) they may be considered “premium” package holders and automatically be given the benefit of a specified redemption deadline for tickets in the package that is later than the standard redemption deadline. If, for example, the standard redemption deadline for open date tickets is 11:59 p.m. the night before a game, premium package holders may take advantage of a later redemption time of, for instance, 4:00 p.m. the day of a game for a night game or 10:00 a.m. the day of the game for day games. Similarly, purchasers of lower-value open date ticket packages may be given the option to redeem their open date tickets after the passing of the redemption deadline for the higher-value open date tickets, and thereby be given the opportunity to upgrade to the higher value seating tiers before those un-used assignable seats are released for general purchase. Alternatively, some organizations in markets with traditionally lower attendance may want to increase attendance by offering all open date ticket package holders a late redemption deadline. Combinations of these features and options also may be implemented.

### Example Option 2

Since one goal of the methods and system of this disclosure is to create more flexibility, sometimes selecting a time period or time window of three months may not be considered sufficiently flexible. To address this, purchasers may be provided with the option to predetermine a subset or limited group of games that they may expect to attend during the season. In such an option, a pre-determined dollar amount can be determined for every game in the predetermined subset of games that is available to be redeemed, and the package can be priced accordingly. Teams with higher traditional attendance can apply dynamic pricing models that determine which games are expected to be of greater value and the cost of the “game specific” package is set according to the values of the selected games. Of course, the tickets in the package do not have to be redeemed for all of the games in the predetermined subset of games, since the tickets still retain their “open date” characteristics and can, for instance, all be redeemed for any one of the games or for any combination of games in the predetermined subset of games.

For example, a purchaser may purchase an open date ticket package of a hundred open date tickets to be used over the course of an entire season of eighty-one home games. However, the purchaser plans on being on vacation for certain weeks in June and July. The purchaser selects the games that he or she may want to attend that excludes any games during the time he or she expects to be on vacation. Depending upon the franchise, historical attendance and pricing, the cost of the ticket package may vary as a function of the games selected even though the number of tickets and the section of the stadium selected may be the same as lower priced ticket packages.

### Example Option 3

In another aspect of the present disclosure, an organization may create “Value Packs” to supplement existing forms of ticket packages. For instance, the organization may select a collection of their historically lowest attended games and offer discounts for the cost of an open date ticket package including these games. The discounted packages may be added to regular priced open date ticket packages, offered as stand alone packages, or offered as supplements to traditional fixed date ticket packages. They may also be offered as incentives to encourage purchasers to buy larger packages of regular or open date ticket packages. For example, every twenty open date tickets added to a package of open date tickets may increase the discount made available for the entire package.

In another aspect of the present disclosure, automated open date tickets may be created using information provided by purchasers when packages are purchased and the tickets redeemed, in conjunction with general and historical attendance information. The system of the present disclosure can, for instance, evaluate consumer behavior, predict future trends based upon such evaluation, and automatically develop open date ticket packages that better suit the needs and tendencies of purchasers and that, with more certainty, maximize revenues to the organization. In addition, the wealth of data generated by the system during use may be used to enhance the relationship between sports organizations and their ticket purchasers and fans.

The invention has been described herein generally within the context of ticket packages to a season of sports events such as a baseball season or a football season. However, the invention is not so limited and may be applied to any type of season that consists of a series of events or event series. For example, the system may be applied to a symphony season, a concert season, theatrical season, a racing season, a series of seminars, a series of classes on various topics, or any other group of events with respect to which attendees may want flexibility in attendance dates. Furthermore, paper or physical tickets need not be involved at all. The open date tickets can be completely virtual with only the ticket to an assigned seat being printed and made available at will call or similar location where the open date ticket can be redeemed. Moreover, the actual tickets to the assigned seats may also be made available in electrical format on a smartphone or similar devices, and can be presented at the stadium or venue as a scannable image that also allows entry to the ticket holder. These and other additions, deletions, and modifications might well be made to the embodiments described above without departing from the spirit and scope of the invention represented thereby.

1. A method of selling assigned seats tickets, through a domain website on the Worldwide Web, to an elected event in an event series, the method comprising:
for a designated plurality of events in the event series, setting aside a plurality of assignable seats from all the seats in a venue hosting the event series;
subdividing the plurality of assignable seats into a plurality of seating tiers, with each of the assignable seats in a seating tier having substantially the same value;
offering, by an electronic processor, open date ticket packages comprising a plurality of open date tickets to purchasers, each of the open date ticket packages being associated with a seating tier and with the open date tickets being redeemable for an assignable seat in that seating tier;
accepting, by an electronic processor, payment from a purchaser in exchange for at least one open date ticket package associated with an initial seating tier;
establishing a redemption deadline prior to the elected event by which the open date tickets in the at least one open date ticket package may be redeemed;
prior to the redemption deadline, receiving, by an electronic processor, a request to redeem a selected number of open date tickets from the at least one open date ticket package, the selected number ranging between one open date ticket and all remaining open date tickets in the at least one open date ticket package; and
redeeming, by an electronic processor, the selected number of open date tickets for a selected number of assigned seat tickets chosen from the assignable seats at the elected event, the assignable seats being unavailable for general purchase at the elected event prior to the redemption deadline.

2. The method of claim 1, wherein the selected number of assigned seat tickets are located in the initial seating tier.

3. The method of claim 1, wherein the selected number of assigned seat tickets are located in a downgraded seating tier having a lesser value than the initial seating tier.

4. The method of claim 1, wherein redeeming the selected number of open date tickets further comprises paying a fee to upgrade the initial seating tier of the selected number of open date tickets to an upgraded seating tier having a greater value than the initial seating tier.

5. The method of claim 1, further comprising changing the location within the venue of the assignable seats in the initial seating tier for the elected event.

6. The method of claim 1, further comprising changing the total number of the assignable seats in the initial seating tier for the elected event.

7. The method of claim 1, wherein the designated plurality of events in the event series further comprises events occurring during a predetermined window of time.

8. The method of claim 7, wherein the predetermined window of time is selected from the group consisting of weekdays, weekend, afternoons and evenings.

9. The method of claim 1, wherein at least one of the offered open date ticket packages further comprises a electronic gift package including electronic credit for a predetermined plurality of open date tickets.

10. The method of claim 1, wherein at least one of the offered open date ticket packages further comprises a gift card including electronic credit for a predetermined plurality of open date tickets.

11. A method for obtaining assigned seat tickets, through a domain website on the Worldwide Web, to an elected event in an event series, the method comprising:
purchasing, by an electronic processor, a ticket package comprising a plurality of open date tickets to an event series, each of the plurality of open date tickets being associated with an event-day classification for the event series and an initial seating tier in a range of seating tiers for a venue hosting the event series;
electing to attend at least one event in the event series corresponding to the event-day classification of the purchased open date tickets;
selecting, by an electronic processor, a number of open date tickets to be redeemed at the elected event, the selected number ranging between one open date ticket and all remaining open date tickets in the ticket package; and
prior to a redemption deadline before the elected event, redeeming, by an electronic processor, the selected number of open date tickets for a selected number of assigned seat tickets to the elected event, the assignable seats being unavailable for general purchase at the elected event prior to the redemption deadline.

12. The method of claim 11, wherein the seating tier of the assigned seat tickets corresponds to the initial seating tier of the purchased open date tickets.

13. The method of claim 11, wherein the seating tier of the assigned seat tickets corresponds to a lower seating tier having a lesser value than the initial seating tier.

14. The method of claim 11, wherein redeeming the selected number of open date tickets further comprises paying a fee to upgrade the initial seating tier of the purchased open date tickets to the upgraded seating tier.

15. The method of claim 11, wherein the event series comprises a season of home games for a sporting team.

16. The method of claim 11, wherein the sporting team plays in a professional sports league selected from the group of professional sports leagues for baseball, football, basketball, hockey, soccer.

17. The method of claim 11, wherein the event-day classification is for less than all the home games in the regular season.

18. The method of claim 17, wherein a basis for the event-day classification is selected from the group consisting of the day of the week of the game, the time of day of the game, the type of opponent at the game, and games that take place during a selected time period for the game.

19. The method of claim 11, wherein the event series comprises a season of sporting events having similar seating arrangements at different geographical locations.

20. The method of claim 11, wherein the event series comprises a season of musical concerts at a concert venue.

21. The method of claim 11, wherein the event-day classification for the event series is customizable by the purchaser of the open date tickets.

22. The method of claim 11, wherein a spatial configuration of the seating tiers for the elected event is changed prior to redeeming the selected number of open date tickets for the selected number of assigned seat tickets to the elected event.

23. A method for selling seat tickets, through a domain website on the Worldwide Web, to one or more events in an event series, the method comprising:
for a designated plurality of events in the event series, setting aside a plurality of assignable seats from all the seats in a venue hosting the event series;
offering, by an electronic processor, open date ticket packages comprising open date tickets redeemable for tickets to the assignable seats;
accepting, by an electronic processor, payment from purchasers in exchange for the open date ticket packages;
establishing a redemption deadline for an elected event before which the open date tickets in the open date ticket packages may be redeemed for assigned seats chosen from the assignable seats at the elected event, the assignable seats being unavailable for general purchase at the elected event prior to the redemption deadline;
prior to the redemption deadline, receiving, by an electronic processor, requests to redeem a selected number of open date tickets from the open date ticket packages, the selected number ranging between one open date ticket and all remaining open date tickets in the open date ticket packages; and
redeeming, by an electronic processor, the selected number of open date tickets for the selected number of assigned seat tickets chosen from the assignable seats at the elected event.

24. The method of claim 23, wherein the designated plurality of events in the event series further comprises a season of home games for a sporting team.

25. A method of selling assigned seats tickets, through a domain website on the Worldwide Web, to a series of similar events or event series, the method comprising:
for a designated plurality of events in the event series, setting aside a plurality of assignable seats from all the seats in a venue hosting the event series;
subdividing the plurality of assignable seats into a plurality of seating tiers, with each of the assignable seats in a seating tier having substantially the same value;
offering, by an electronic processor, open date ticket packages comprising a plurality of open date tickets to purchasers, each of the open date ticket packages being associated with a seating tier and with the open date tickets being redeemable for an assignable seat in that seating tier;
accepting, by an electronic processor, payment from a purchaser in exchange for at least one open date ticket package associated with an initial seating tier;
prior to an elected event, changing the location within the venue of the assignable seats in the initial seating tier for that elected event;
establishing a redemption deadline prior to the elected event by which the open date tickets in the at least one open date ticket package may be redeemed;
prior to the redemption deadline, receiving, by an electronic processor, a request to redeem a selected number of open date tickets from the at least one open date ticket package, the selected number ranging between one open date ticket and all remaining open date tickets in the at least one open date ticket package; and
on a first-come, first-serve basis for that elected event, redeeming, by an electronic processor, the selected number of open date tickets in the at least one open date ticket package for a selected number of assigned seat tickets chosen from the assignable seats in the initial seating tier, the assignable seats being unavailable for general purchase at the elected event prior to the redemption deadline.

26. The method of claim 25, further comprising changing the total number of the assignable seats in the initial seating tier for that elected event.
